(19) United States
(12) Patent Application Publication
(10) Pub. No.: US 2009/0185534 A1
(43) Pub. Date: Jul. 23, 2009

(54) Method and Apparatus for Transmitting a Packet Header

(75) Inventors: Phillip Barber, McKinney, TX (US); Sean Michael McBeath, Keller, TX (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/354,654

(22) Filed: Jan. 15, 2009

Related U.S. Application Data
(60) Provisional application No. 61/022,257, filed on Jan. 18, 2008.

(51) Int. Cl. H04W 4/00; H04L 12/56; H04J 3/18

(52) U.S. Cl. 370/330; 370/393; 370/477

(57) ABSTRACT

A system and method for transmitting a reduced header is presented. A preferred embodiment comprises a base station defining a normal header and a reduced header, wherein the reduced header has a smaller number of bytes than the normal header. The base station then concatenates the reduced header with smaller sized payloads and concatenates the normal header with larger sized payloads.

This application claims the benefit of U.S. Provisional Application No. 61/022,257, filed on Jan. 18, 2008, entitled “Method and Apparatus for Transmitting a Packet Header in a Wireless Communication System,” which application is hereby incorporated herein by reference.

### TECHNICAL FIELD

The present invention relates generally to a system and method for transmitting data, and more particularly to a system and method for transmitting packets of data in a wireless communication system with a reduced packet header.

### BACKGROUND

Generally, transmitters transmit data packets along with a header. This header contains information relating to the payload such as the type of payload, information about the payload's content, the payload's intended destination, and/or other parameters related to the payload. As such, this header is an important part of the transmitted data packet.

However, this header generally has a relatively static size regardless of the amount of data actually being transmitted. For smaller payloads such as voice over internet protocols (VoIP), the amount of actual data may be small, causing the header to make up a significantly large percentage of the data transmitted. For these smaller payloads, the inclusion of the header causes the overall packet to be proportionally larger than it could be, causing more bandwidth to be used to transmit the packet.

### SUMMARY OF THE INVENTION

These and other problems are generally solved or circumvented, and technical advantages are generally achieved, by preferred embodiments of the present invention which provides for a reduced header.

In accordance with a preferred embodiment of the present invention, a method for transmitting data comprises defining a first header with a first size and a second header with a second size. The second header has a second size less than the first size. The second header is concatenated with a payload to form a packet, and the packet is transmitted to a mobile station.

In accordance with another preferred embodiment of the present invention, a method for receiving a transmission comprises receiving a first packet comprising a first header with a first number of bytes. Receiving a second packet comprising a second header, the second header comprising a second number of bytes smaller than the first number of bytes.

In accordance with yet another preferred embodiment of the present invention, a method of transmitting data comprises defining a first header and a reduced header, the reduced header having a smaller number of bytes than the first header. A payload is provided, and the payload and one of either the first header or the reduced header is concatenated with the payload, depending upon the size of the payload.

An advantage of a preferred embodiment of the present invention is a reduction in bandwidth requirements for packets having a smaller size when they use a reduced header.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a wireless communications network in accordance with an embodiment of the present invention;

FIG. 2 illustrates a base station and several mobile stations from a wireless communications network in accordance with an embodiment of the present invention;

FIG. 2A illustrates the different types of connection identifiers that can be assigned to a mobile station in accordance with an embodiment of the present invention;

FIGS. 3-6 illustrate an example set of orthogonal frequency division multiple access (OFDMA) time-frequency radio resources in accordance with an embodiment of the present invention;

FIG. 7 illustrates an illustrative example of OFDMA assignments for four mobile stations 120 in accordance with an embodiment of the present invention;

FIG. 8 illustrates an example assignment message in accordance with an embodiment of the present invention;

FIG. 9 illustrates a block diagram of a preferred packet in accordance with an embodiment of the present invention;

FIG. 10 illustrates a block diagram of a packet in accordance with an embodiment of the present invention;

FIG. 11 illustrates a message for associating connection identifiers with header types in accordance with an embodiment of the present invention;

FIG. 12 illustrates an assignment message in accordance with an embodiment of the present invention;

FIG. 13 illustrates a flow chart for BS operation in accordance with an embodiment of the present invention; and

FIG. 14 illustrates a flow chart for mobile station operation in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely transmitting a packet header in a wireless communication system. The invention may also be applied, however, to other data transmission systems.

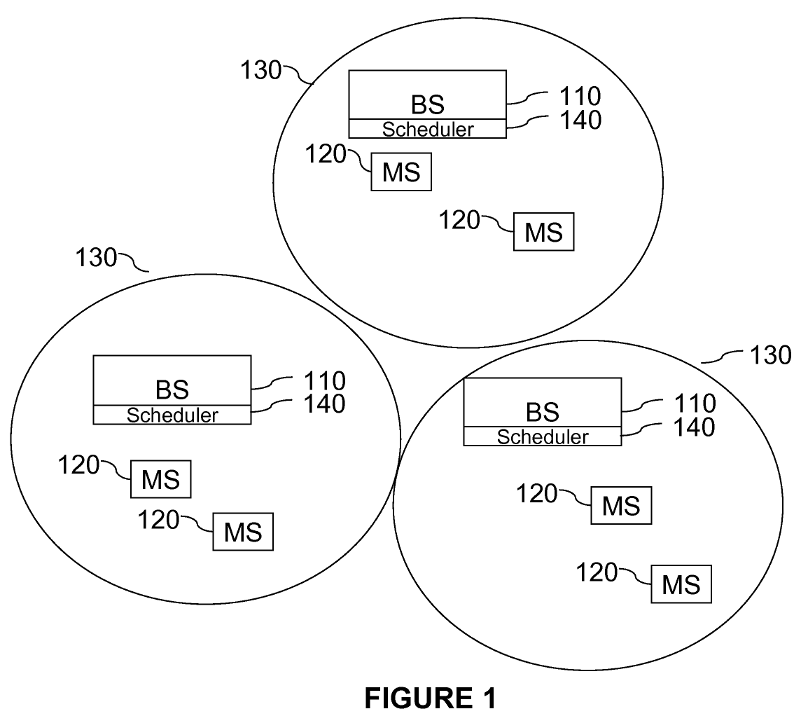

With reference now to FIG. 1, there is shown a wireless communications network which preferably comprises a plurality of base stations (BS) 110 providing voice and/or data wireless communication service to a plurality of mobile stations (MS) 120. The BSs 110, which may also be referred to by other names such as access network (AN), access point (AP), Node-B, etc., preferably downlink (DL) information to the MSs 120 while also receiving uplink (UL) information from the MSs 120.

Each BS 110 preferably has a corresponding coverage area 130. These coverage areas 130 represent the range of each BS 110 to adequately transmit data, and, while not necessarily shown in FIG. 1, the coverage areas 130 of adjacent BSs 110 preferably have some overlap in order to accommodate handoffs between BSs 110 whenever a MS 120 exits one coverage area 130 and enters an adjacent coverage area 130. Each BS 110 also preferably includes a scheduler 140 for allocating radio resources to the MSs 120.

Preferably, the wireless communications network includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

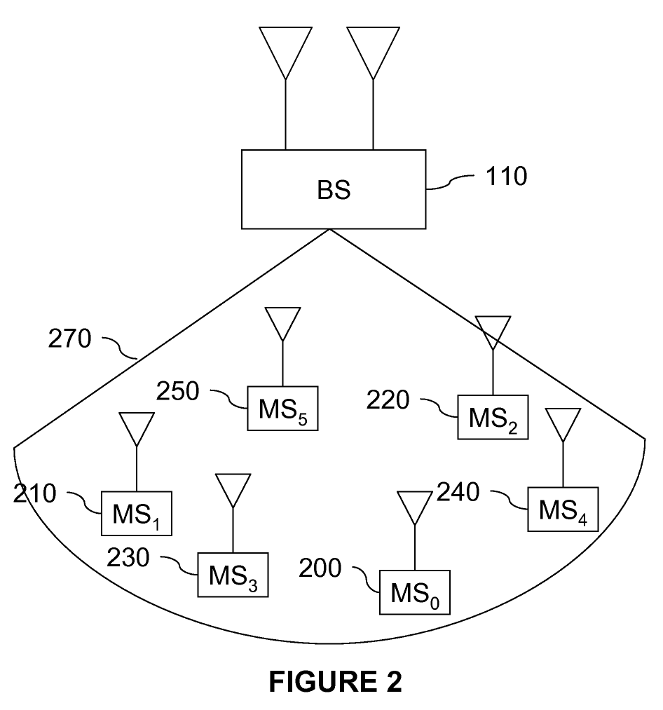

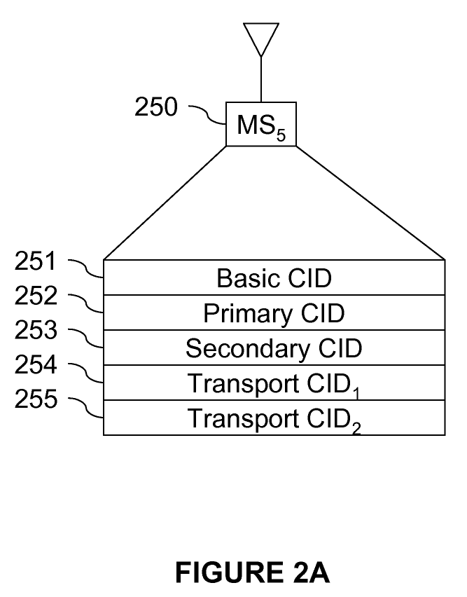

FIG. 2 illustrates one BS 110 and several MSs 120 from the wireless communications network of FIG. 1. As illustrated, the coverage area 130 shown in FIG. 1 is preferably divided into three reduced coverage areas 270, one of which is shown in FIG. 2. Six MSs 120 illustrated in FIG. 1 are individually shown in the reduced coverage area 270 as MS₀ 200, MS₁ 210, MS₂ 220, MS₃ 230, MS₄ 240, and MS₅ 250. The BS 110 typically assigns each of these MSs 120 one or more connection identifiers (CID) (or another similar identifier) to facilitate time-frequency resource assignments. The CID assignments are preferably transmitted from the BS 110 to MS₀ 200, MS₁ 210, MS₂ 220, MS₃ 230, MS₄ 240, and MS₅ 250 on a control channel, although the CID assignments can alternatively be permanently stored at the MSs 120, or else can be derived based on a parameter of either the MSs 120 or BS 110.

FIG. 2A illustrates the different types of connection identifiers that can be assigned to the MSs 120 (e.g., MS₅ 250), although this is merely illustrative as these or other connection identifiers may be assigned to any of the MSs 120 located within the reduced coverage area 270. In this preferred embodiment, MS₅ 250 preferably has five connection identifiers (CIDs), namely a basic CID 251, a primary CID 252, a secondary CID 253, and two transport CIDs, transport CID₁ 254 and transport CID₂ 255. These different connection identifiers can be associated with different control types, quality of service types, traffic types, and the like. For example, the basic CID 251 is preferably used for transmitting control information, transport CID₁ 254 is preferably used for a voice over internet protocol (VoIP) call, and transport CID₂ 255 is preferably used for an internet session. All CIDs except the basic CID 251 may also be referred to generally as supplementary connection identifiers. The connection identifier may also be referred to as a station identifier, MAC address, MS identifier, etc.

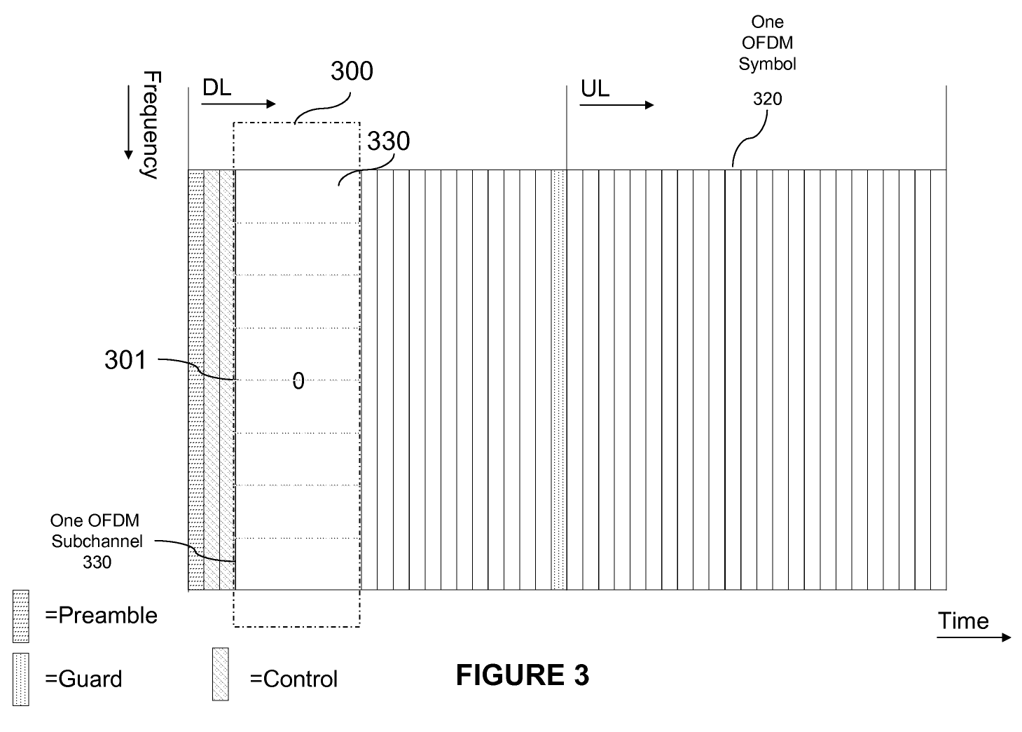

FIGS. 3-6 illustrate preferred embodiments of OFDMA time-frequency radio resources. In OFDMA systems, the time-frequency resources are preferably divided into OFDM symbols 320 and OFDM subcarriers for allocation to the MSs 120 by the BS 110 scheduler 140. In an example OFDMA system, the OFDM subcarriers are preferably approximately 10 kHz apart and the duration of each OFDM symbol is approximately 100 μs.

Referring to FIG. 3, the time-frequency resources preferably correspond to a time division duplex (TDD) system, such as that defined by the IEEE 802.16e standard. In this exemplary embodiment, the resources in the time domain (represented by the x-axis) are divided into two equal portions; denoted as downlink (DL), and uplink (UL). The DL and UL are further divided into 24 OFDM symbols 320. The first DL OFDM symbol 320 is preferably allocated for a preamble, which is used for timing and frequency synchronization by the MSs 120. The second DL OFDM symbol 320 and the third DL OFDM symbol 320 are preferably used to transmit control information. The twenty-fourth DL OFDM symbol 320 is preferably allocated as a guard period.

In the frequency domain (represented by the y-axis), the fourth DL OFDM symbol 320 through the eleventh DL OFDM symbol 320 are preferably further divided into eight OFDM subchannels 330. The OFDM subchannels 330 preferably contain 48 usable OFDM subcarriers (e.g., subcarriers that may be used for data transmission) that may be located either contiguous to each other or else distributed across a larger bandwidth.

In the preferred embodiment illustrated in FIG. 3, the fourth DL OFDM symbol 320 through the eleventh DL OFDM symbol 320 are preferably allocated as a zone (also called region) 300 which is preferably divided into various combinations of distinct time-frequency resource assignments. These distinct time-frequency resource assignments are preferably referred to as a node and each node in FIGS. 3-6 is given a separate number (e.g., node 0 in FIG. 3).

FIG. 3 illustrates a first largest time-frequency resource assignment 301, labeled as node 0, which is also the largest time-frequency resource assignment 301. Preferably, the time-frequency resource assignment 301 is 8 OFDM symbols by 384 usable OFDM subcarriers, although any suitable number of OFDM symbols and OFDM subcarriers may alternatively be utilized.

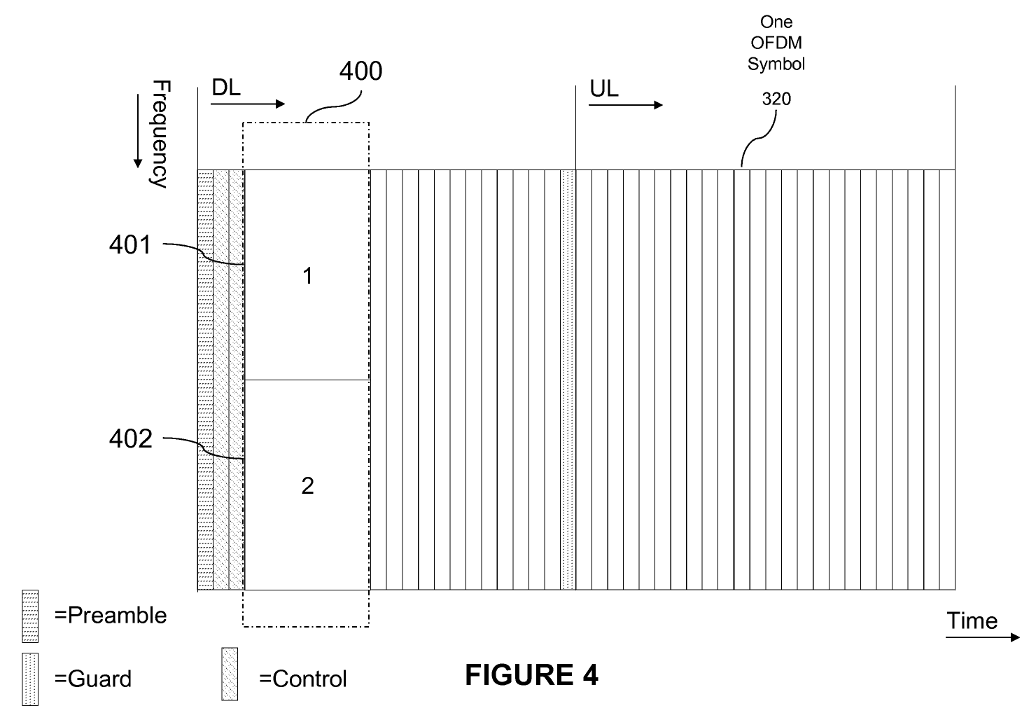

FIG. 4 illustrates an embodiment with two time-frequency resource assignments, a second time-frequency resource assignment 401 and a third time-frequency resource assignment 402, also labeled as node 1 and node 2, respectively. With only two time-frequency resource assignments, the second time-frequency resource assignment 401 and the third time-frequency resource assignment 402 are the two next largest time-frequency resource assignments after the first time-frequency resource assignment 301 (illustrated in FIG. 3). In this embodiment the second time-frequency resource assignment 401 and the third time-frequency resource assignment 402 are each preferably 8 OFDM symbols 320 by 192 usable OFDM subcarriers, although any suitable number of OFDM symbols 320 and OFDM subcarriers may alternatively be utilized.

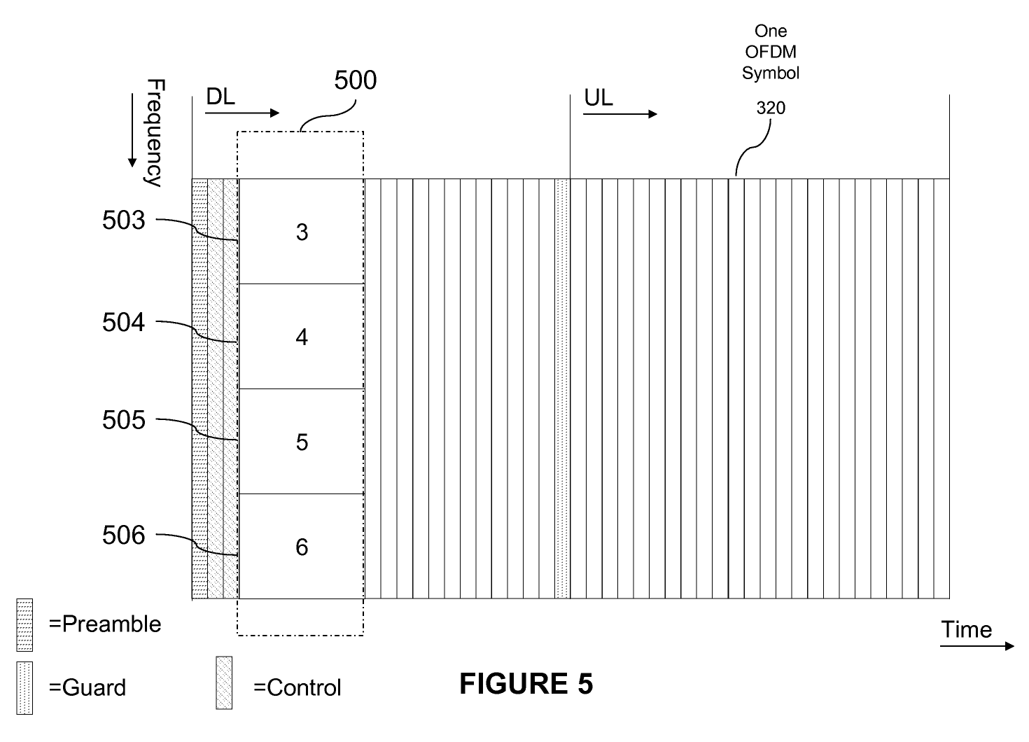

FIG. 5 illustrates an embodiment with four time-frequency resource assignments: a fourth time-frequency resource assignment 503, a fifth time-frequency resource assignment 504, a sixth time-frequency resource assignment 505, and a seventh time-frequency resource assignment 506, also labeled as node 3, node 4, node, 5, and node 6, respectively. With four time-frequency resource assignments, the fourth time-frequency resource assignment 503, the fifth time-frequency resource assignment 504, the sixth time-frequency resource assignment 505, and the seventh time-frequency resource assignment 506 are the four next largest time-frequency resource assignments after the second time-frequency resource assignment 401 and the third time-frequency resource assignment 402. In this embodiment, the fourth time-frequency resource assignment 503, the fifth time-frequency resource assignment 504, the sixth time-frequency resource assignment 505, and the seventh time-frequency resource assignment 506 are each preferably 8 OFDM symbols 320 by 96 usable OFDM subcarriers, although any suitable number of OFDM symbols 320 and usable OFDM subcarriers may be utilized.

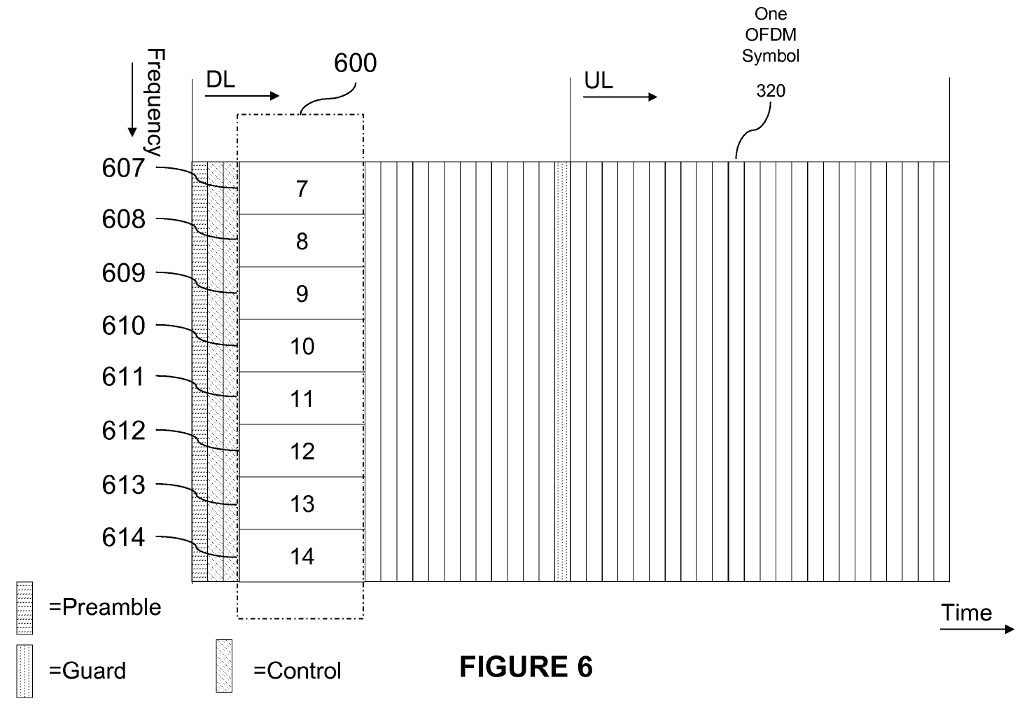

FIG. 6 illustrates an embodiment with eight time-frequency resource assignments: an eighth time-frequency resource assignment 607, a ninth time-frequency resource assignment 608, a tenth time-frequency resource assignment 609, an eleventh time-frequency resource assignment 610, a twelfth time-frequency resource assignment 611, a thirteenth time-frequency resource assignment 612, a fourteenth time-frequency resource assignment 613, and a fifteenth time-frequency resource assignment 614, also labeled as node 7, node 8, node 9, node 10, node 11, node 12, node 13, and node 14, respectively. With eight time-frequency resource assignments, the eighth time-frequency resource assignment 607, the ninth time-frequency resource assignment 608, the tenth time-frequency resource assignment 609, the eleventh time-frequency resource assignment 610, the twelfth time-frequency resource assignment 611, the thirteenth time-frequency resource assignment 612, the fourteenth time-frequency resource assignment 613, and the fifteenth time-frequency resource assignment 614 are the eight next largest time-frequency resource assignments after the fourth time-frequency resource assignment 503, the fifth time-frequency resource assignment 504, the sixth time-frequency resource assignment 505, and the seventh time-frequency resource assignment 506. In this embodiment, each of the eighth time-frequency resource assignment 607, the ninth time-frequency resource assignment 608, the tenth time-frequency resource assignment 609, the eleventh time-frequency resource assignment 610, the twelfth time-frequency resource assignment 611, the thirteenth time-frequency resource assignment 612, the fourteenth time-frequency resource assignment 613, and the fifteenth time-frequency resource assignment 614 preferably comprise 8 OFDM symbols 320 by 48 usable OFDM subcarriers, although any suitable number of OFDM symbols 320 and usable OFDM subcarriers may be utilized.

In FIGS. 3-6, each node (e.g., nodes 0-14) preferably corresponds to a logical representation of the time-frequency resources of the overall system. Each logical time-frequency resource (e.g., the first time-frequency resource assignment 301) preferably maps to a physical time-frequency resource. The mapping of logical time-frequency resources to physical time-frequency resources depends at least in part on which subcarrier permutation is being used, such as the subcarrier permutations defined by the IEEE 802.16 standard, and any suitable subcarrier permutation may be utilized. Furthermore, this mapping of logical time-frequency resources to physical time-frequency resources can also change with time and can depend on one or more parameters defined by the system. In some embodiments, there may be a default subcarrier permutation, which is used by the BS 110 and the MS 120 until the BS 110 sends a control channel message to alter the subcarrier permutation. Any mapping of logical time-frequency resources to physical time-frequency resources can be used as long as it is known both at the BS 110 and MS 120. For example, the logical time-frequency node 7 can map to physical OFDM symbols 4-11 and physical OFDM subcarriers 0-47 for one subcarrier permutation, referred to as a contiguous permutation, while a different subcarrier permutation may map logical time-frequency node 7 to physical OFDM symbols 4-11 and physical OFDM subcarriers 0, 8, 16, 24 . . . 376, referred to as a distributed permutation.

Furthermore, as one of skill in the art will recognize, while all of the time-frequency resource assignments described above are shown as being located only with other time-frequency resource assignments of the same size (e.g., the eight time-frequency resource assignment 607 is located with equally sized thirteenth time-frequency resource assignment 612), the time-frequency resource assignments are not intended to be limited to this illustrative example. Each of these differently sized time-frequency resource assignments may be combined with any or all of the other sizes and any suitable combination of different sized time-frequency resource assignments are intended to be included within the scope of the present invention. For example, the eleventh time-frequency resource assignment 610 and the twelfth time-frequency resource assignment 611 may be combined along with the third time-frequency resource assignment 402 and the fourth time-frequency resource assignment 503.

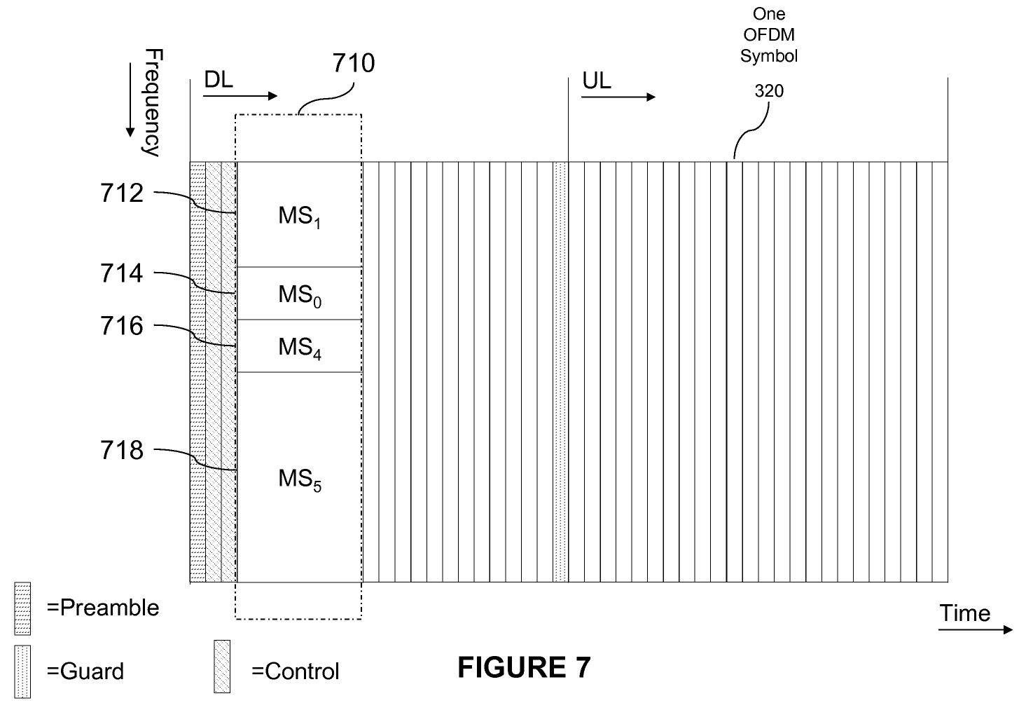

FIG. 7 illustrates preferable OFDMA assignments for four of the MSs 120: MS₀ 200, MS₁ 210, MS₄ 240, and MS₅ 250 described above with respect to FIG. 2. For each frame, the scheduler 140 preferably determines which MSs 120 will be allocated time-frequency resources along with the size of the allocation, and then transmits the information associated with the assignments to the MSs 120. For example, consider that the scheduler 140 has determined to assign node 3 to MS₁ 712, node 9 to MS₀ 714, node 10 to MS₄ 716, and node 2 to MS₅ 718, as shown in FIG. 7. The scheduler 140 transmits an indication of these assignments to the MSs 120 using an assignment message which is transmitted on a control channel, and the MSs 120 determine their respective time-frequency resources.

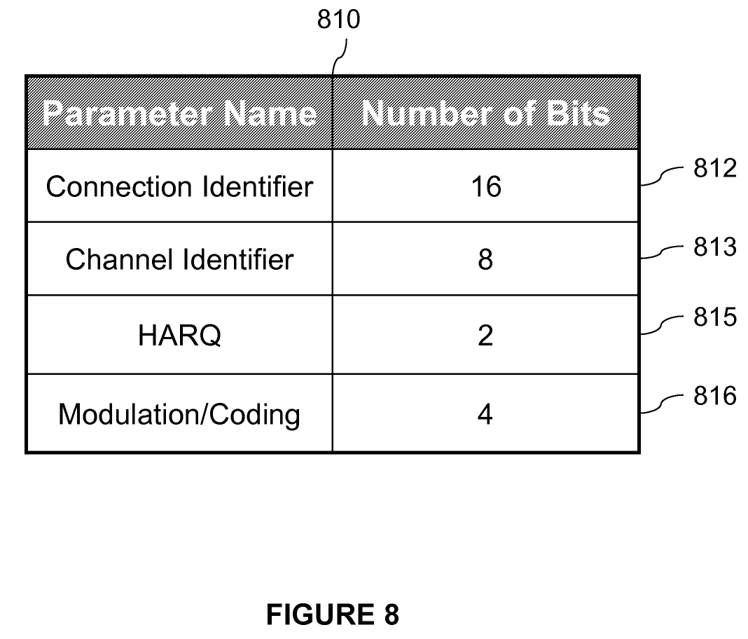

FIG. 8 illustrates the fields of an illustrative assignment message 810. The assignment message 810 preferably contains a 16 bit field indicating the connection identifier 812 of the MS 120, wherein the connection identifier 812 corresponds to one or more MSs 120. The assignment message 810 additionally preferably contains an 8 bit channel identifier field 813, wherein the channel identifier identifies a pre-defined time-frequency resource, such as the ones described above with respect to FIGS. 3-6, and a 2 bit hybrid automatic repeat request (HARQ) field 815, wherein the HARQ field contains information relevant to the HARQ process, such as sub-packet identifier. The assignment message 810 also preferably contains a four bit field indicating the modulation and coding 816 required to decode the transmitted data.

However, as one of skill in the art will recognize, the above described illustrative assignment message 810 is merely one illustrative embodiment that may be used with the present invention. Not all of the illustrated parameters have to be used in all embodiments, some parameters may be omitted based on the value of other parameters, and additional parameters may be included in some embodiments. For example, the MS 120 may use a combination of the modulation/coding field 816 and the channel identifier field 813 to determine the cumulative size of the transmission.

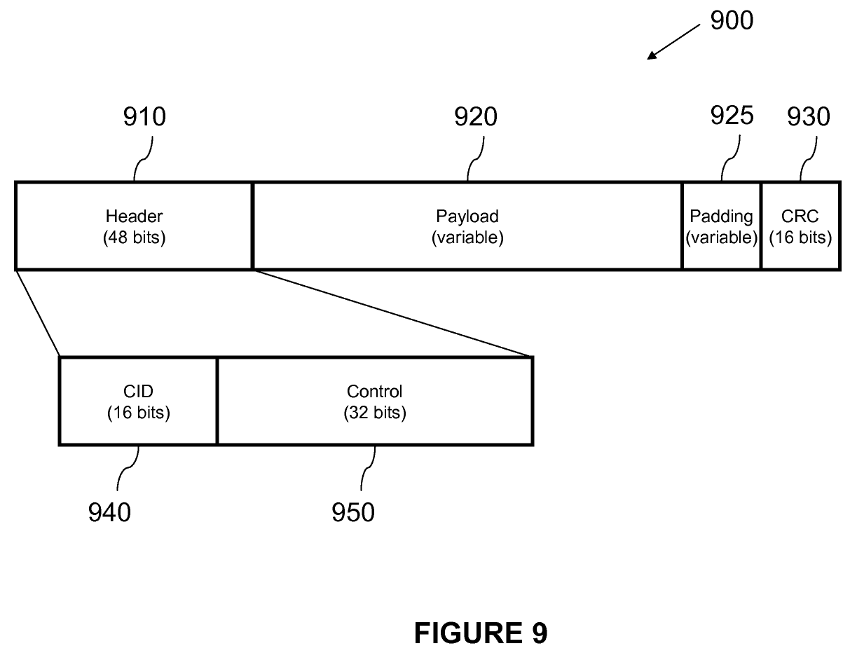

FIG. 9 illustrates a block diagram of a preferred, larger packet 900 sent from the BS 110 to the MS 120 as is known in the prior art for the transmission of larger data packets such as internet transmissions. The larger packet 900 preferably comprises a header 910, payload 920, padding bits 925, and cyclic redundancy check (CRC) 930. The payload 920 preferably comprises the data that is desired to be transmitted between the BS 110 and the MSs 120.

The CRC 930 is preferably used to check for any errors or alterations that may occur during transmission. The CRC 930 is preferably appended at the transmitter by taking the values of the header 910, the payload 920, and the padding bits 925 and producing a 16 bit value. The MS 120 preferably applies the same operation on the header 910, the payload 920, and the padding bits 925 to produce a received version of the CRC 930, while extracting the CRC bits 930 as the transmitted version of the CRC 930. If the received version of the CRC 930 matches the transmitted version of the CRC 930, then the MS 120 determines that it has correctly received the header 910, the payload 920, and padding bits 925. The CRC 930 preferably has a 16 bit field, although any suitable CRC size may alternatively be used.

Padding bits 925 are preferably added to the packet if the payload 920, the header 910, and the CRC 930, combined, do not match the supported packet sizes in the preferred wireless system. As such, the number of padding bits 925 is variable based upon the sizes of the header 910, the CRC 930, and the payload 920, and is preferably added by the BS 110. Once the larger packet 900 has been received by the MS 120, the MS 120 preferably removes the padding bits 925 based on the known size of the payload 920 prior to processing the payload 920.

The header 910 is preferably further divided into a connection identifier field (CID) 940 and other control information 950. The header 910 typically has a fixed size of 48 bits in the prior art, which is a significant amount of overhead for small packets 900, such as VoIP packets. Thus, it is preferable to reduce the size of the header 910 for certain applications, like VoIP while also maintaining the 48 bit larger headers 910 for larger packets 900.

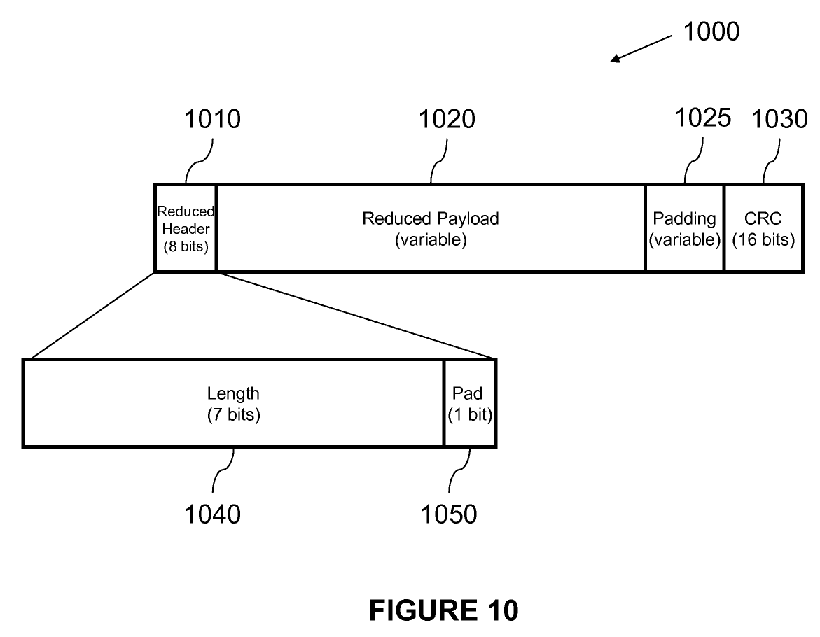

FIG. 10 illustrates a preferred reduced packet 1000 comprising a reduced header 1010, along with a reduced payload 1020, padding bits 1025, and a CRC 1030, wherein the reduced payload 1020, padding bits 1025, and CRC 1030 are preferably similar to the payload 920, padding bits 925, and CRC 930 described above with respect to FIG. 9 except for their size. The reduced header 1010 preferably has a reduced number of bytes from the header 910 described above with respect to FIG. 9. The reduced header 1010 preferably eliminates the CID indication 940 as well the other control information 950 and simply contains an indication of the size of the reduced payload 1020. With this elimination, the reduced header 1010 preferably only comprises 8 bits, with the length 1040 of the reduced header 1010 preferably being 7 bits along with a single bit of padding 1050.

However, such a reduced header 1010, while compatible and actually preferable with smaller packets 900, such as VoIP packets, is not necessarily compatible with the larger packets 900. As such, in preferred embodiments, it is preferable for the BS 110 to define both the normal header 910 and the reduced header 1010. The normal header 910 and the reduced header 1010 are then preferably used with an appropriately sized packet. For example, the reduced header 1010 may be utilized with smaller packets 1000 such as VoIP packets, while the normal header 910 may be utilized for larger packets 900 such as internet transmissions.

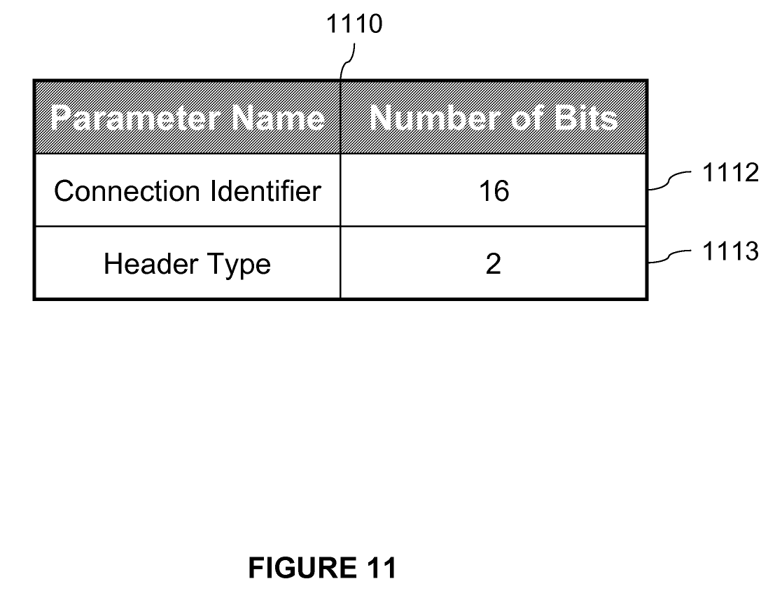

With the BS 110 defining both a normal header 910 and a reduced header 1010, the BS 110 preferably informs the MSs 120 which header is intended to be used for which packets. To inform the MS 120 whether the normal header 910 or the reduced header 1010 is intended to be used for which packets, the BS 110 preferably establishes relationships between the connection identifiers 812 (described above with respect to FIG. 8) and the type of header (reduced header 1010 or normal header 910) using a header association message 1110, such as the one shown in FIG. 11.

In FIG. 11, the header association message 1110 preferably contains a connection identifier 1112 along with a header type 1113. The connection identifier 1112 preferably comprises a 16-bit field, and preferably comprises similar information as the connection identifier 812 described above with respect to FIG. 8. The header type 1113 preferably comprises a 2 bit indication of the type of header (reduced header 1010 or normal header 910). For example, the state ‘00’ could map to a normal header 910, while the state ‘01’ could map to reduced header 1010, although any suitable state could represent any desired type of header. The remaining two states (‘10’ and ‘11’) are preferably reserved for future use.

Once there is a relationship between the connection identifier 1112 and the header type 1113, the MS 120 has the information necessary to process packets targeted for a specific connection identifier 1112. The MS 120 preferably determines the connection identifier 1112 for each packet using the header association message 1110.

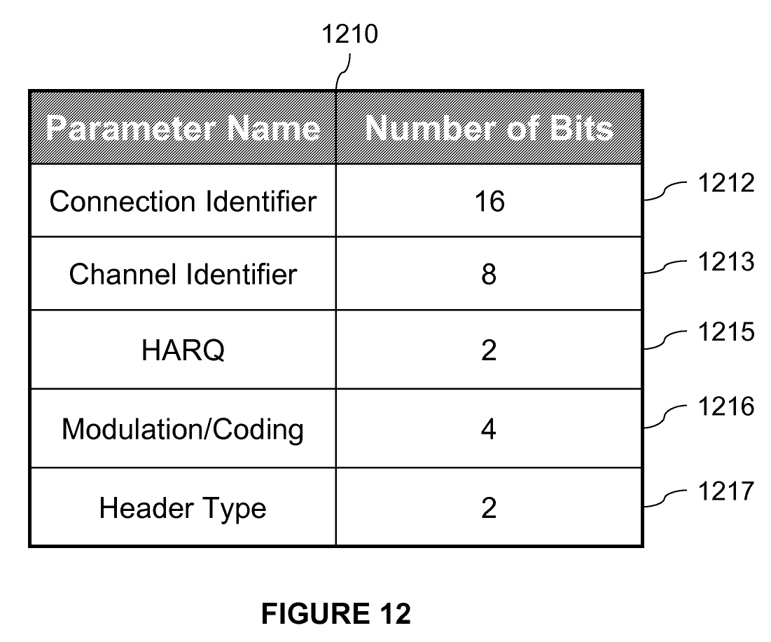

FIG. 12 illustrates another embodiment of the present invention in which the type of header (reduced header 1010 or normal header 910) is preferably included within an assignment message 1210 as a header type field 1217, instead of merely with the connection identifier 1112 (as illustrated in FIG. 11). In this embodiment the remainder of the assignment message 1210 including the connection identifier 1212, the channel identifier 1213, the HARQ field 1215, and the modulation/coding field 1216, is preferably similar to the assignment message 810 described above with respect to FIG. 8. By including the header type 1217 field within the assignment message 1210, the BS 110 may maintain more flexibility in switching between the reduced header 1010 and the normal header 910. In this way, the BS 110 can determine whether to use the reduced header 1010 for each individual packet which is transmitted.

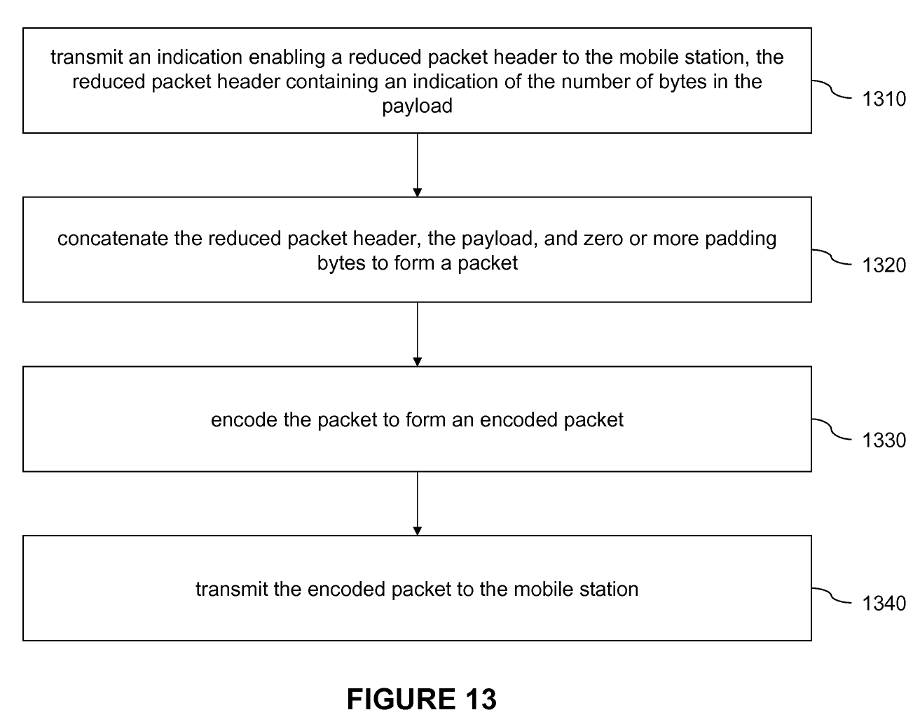

FIG. 13 illustrates a preferred process flow for operation of the BS 110 in accordance with one embodiment of the present invention. At step 1310, the BS 110 transmits an indication enabling a reduced header 1010 to the MS 120, the reduced header 1010 containing an indication of the number of bytes in the payload 1020. In some embodiments, the indication of the number of bytes in the payload 1020 is preferably a 7 bit field, and one additional bit may be appended to the 7 bit field.

Preferably, the indication enabling the reduced header 1010 is transmitted during session establishment with a connection identifier 1112 such as the one described above with respect to FIG. 11. However, in other embodiments, the indication enabling the reduced header 1010 may be transmitted concurrently with the time-frequency resource assignment. For example, the indication can change from packet to packet and can be transmitted using an assignment message 1210, such as the one described above with respect to FIG. 12. However, any suitable transmission may be used to enable the reduced header 1010. Preferably, once the indication enabling the reduced header 1010 is transmitted to the MS 120, the MS 120 uses a capability attribute to tell the BS 110 whether or not the MS 120 supports the reduced header 1010.

At step 1320, the BS 110 preferably concatenates the reduced header 1010, the payload 1020, and zero or more padding bytes 1025 to form the reduced packet 1000. At step 1330, the BS 110 preferably encodes the reduced packet 1000. At step 1340, the base station preferably transmits the encoded reduced packet 1000 to the MS 120.

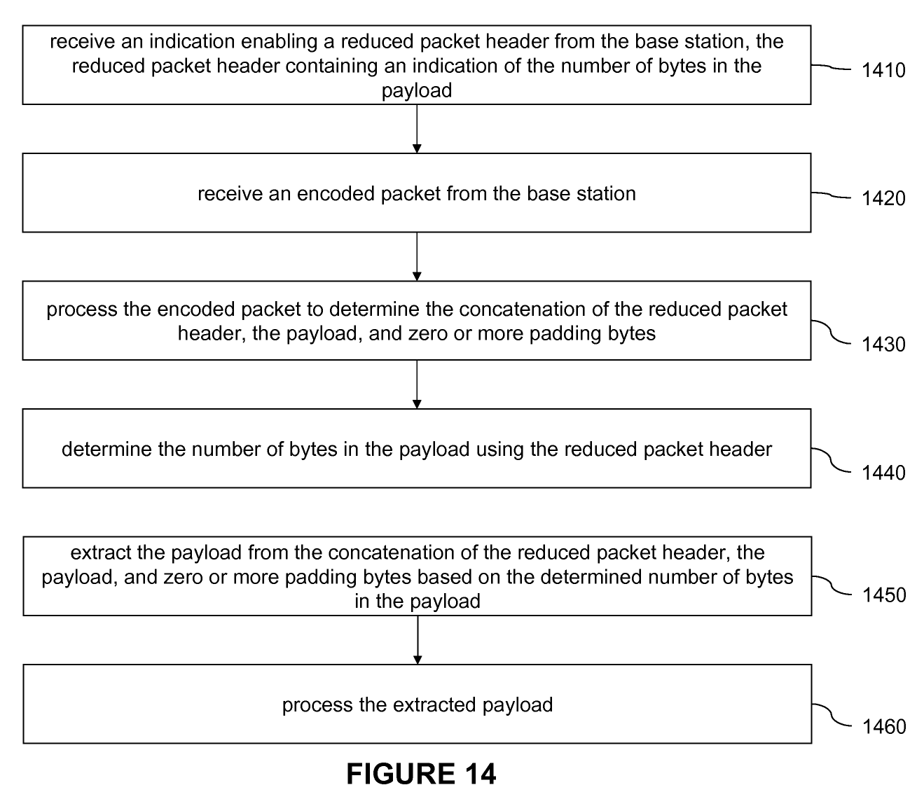

FIG. 14 illustrates a preferred process flow for operation of the MS 120 in accordance with a preferred embodiment of the present invention. At step 1410, the MS 120 preferably receives an indication enabling a reduced header 1010 from the BS 110. In this embodiment, the reduced header 1010 preferably contains an indication of the number of bytes in the payload 1020. At step 1420, the MS 120 preferably receives an encoded packet from the BS 110. At step 1430, the MS 120 preferably processes the encoded packet to determine the concatenation of the reduced header 1010, the payload 1020, and zero or more padding bytes 1025. At step 1440, the MS 120 preferably determines the number of bytes in the payload 1020 using the reduced header 1010. At step 1450, the MS 120 preferably extracts the payload 1020 from the concatenation of the reduced header 1010, the payload 1020, and zero or more padding bytes 1025 based on the determined number of bytes in the payload 1020. At step 1460, the MS 120 preferably processes the extracted payload 1020.

Although the present invention and its advantages have been described in detail, it should be understood that various changes, substitutions and alterations can be made herein without departing from the spirit and scope of the invention as defined by the appended claims. For example, the role of mobile station and base station can be reversed. However, the base station generally has control over when the reduced packet header is used or not. For example, when the mobile station transmits packets to the base station, it uses the reduced packet header if the reduced packet header is enabled by the base station.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transmitting data, the method comprising:
forming a first packet by concatenating a first header with a first payload, the first header having a first size;
forming a second packet by concatenating a second header with a first payload, the second header having a second size less than the first size;
wirelessly transmitting the first packet to a mobile station; and
wirelessly transmitting the second packet to the mobile station.

2. The method of claim 1, further comprising transmitting an enablement of the second header prior to transmitting the second packet.

3. The method of claim 2, wherein the enablement of the second header is transmitted with a time-frequency resource assignment.

4. The method of claim 2, wherein the enablement of the second header is transmitted with an assignment message.

5. The method of claim 1, wherein the second header comprises an indication of a size of the payload.

6. The method of claim 5, wherein the indication of a size of the payload is a 7 bit field.

7. The method of claim 1, wherein forming the second packet comprises concatenating one or more padding bytes with the second header and the second payload.

8. The method of claim 1, wherein the second header comprises seven bits of information and one bit of padding.

9. The method of claim 1, further comprising encoding the first pack packet prior to transmitting the first packet to the mobile station and encoding the second pack packet prior to transmitting the second packet to the mobile station.

10. A method for transmitting data, the method comprising:
receiving a payload;
determining a size of the payload;
determining a header format based upon the size of the payload;
forming a packet by concatenating a header with the payload, the header having the header format determined based upon the size of the payload; and
wirelessly transmitting the packet.

11. The method of claim 10, further comprising transmitting an indication of the determined header format before wirelessly transmitting the packet.

12. The method of claim 11, wherein the indication comprises enablement transmitted with a time-frequency resource assignment.

13. The method of claim 11, wherein the indication comprises an enablement transmitted with an assignment message.

14. The method of claim 10, wherein determining the size of the payload comprises determining whether the payload is a first size or a second size smaller than the first size, and wherein forming the packet comprises concatenating a first header if the payload is the first size and concatenating a second header if the payload is the second size, the second header being smaller than the first header.

15. A method for receiving a transmission, the method comprising:
receiving a first packet comprising a first header, the first header having a first number of bytes; and
receiving a second packet comprising a second header, the second header comprising a second number of bytes smaller than the first number of bytes.

16. The method of claim 15, further comprising receiving a transmission indicating enablement of the second header.

17. The method of claim 16, wherein the transmission is received after receiving the first packet but before receiving the second packet.

18. The method of claim 16, wherein the receiving a transmission indicating enablement of the second header is performed at least in part during session establishment.

19. The method of claim 16, wherein the receiving a transmission indicating enablement of the second header is performed at least in part concurrently with a time-frequency resource assignment.

20. The method of claim 15, wherein the second header comprises an indication of the number of bytes in a payload.

21. The method of claim 15, further comprising processing the second packet to determine a concatenation of the second header and a payload.

22. The method of claim 15, further comprising determining the number of bytes in a payload from the second header.

23. A method of transmitting data, the method comprising:
defining a first header;
defining a reduced header, the reduced header having a smaller number of bytes than the first header;
providing a payload;
forming a packet by concatenating the payload and one of either the first header or the reduced header depending upon the size of the payload; and
wirelessly transmitting the packet.

24. The method of claim 23, further comprising sending an indication enabling the reduced header.

25. The method of claim 24, wherein the indication enabling the reduced header is performed at least in part during session establishment.

26. The method of claim 23, wherein the reduced header comprises a 7 bit field indicating the size of the payload.
